(19) United States
(12) Patent Application Publication
(10) Pub. No.: US 2025/0098713 A1
(43) Pub. Date: Mar. 27, 2025

(54) METHOD FOR PRODUCING A BEVERAGE

(71) Applicant: HORA BEVERAGE COMPANY SRL, Bovolone (VR) (IT)

(72) Inventors: Claudio ANDREOLI, S. Maria di Zevio (VR) (IT); Tommaso ANDREOLI, Crevalcore (BO) (IT); Federico ANDREOLI, Crevalcore (BO) (IT); Giovanni ANDREOLI, Verona (IT)

(73) Assignee: HORA BEVERAGE COMPANY SRL, Bovolone (VR) (IT)

(21) Appl. No.: 18/291,936

(22) PCT Filed: Jul. 22, 2022
(86) PCT No.: PCT/IB2022/056807

§ 371 Date: Jan. 25, 2024

(30) Foreign Application Priority Data
Jul. 27, 2021 (IT) 102021000020036
Jul. 27, 2021 (IT) 102021000020054

(51) Int. Cl. A23L 2/60; A23L 2/06; A23L 2/08; A23L 2/54; A23L 33/15; A23L 33/16

(52) U.S. Cl. CPC A23L 2/60; A23L 2/06; A23L 2/08; A23L 2/54; A23L 33/15; A23L 33/16

(57) ABSTRACT

Method for producing a beverage includes: preparing a volume of concentrated fruit juice; preparing a volume of concentrated elderberry juice; first mixing the volume of concentrated fruit juice, and elderberry juice, together with a first volume of water and a mass of vitamins, to obtain a compound; second mixing, in which within a volume of water, 45-65 g of the compound for each liter of water and 90-110 g of honey for each liter of water is mixed, to obtain the beverage, which includes: fruit juice concentrate between 15-25% of the total mass of the beverage; vitamins between 3-6 mg per 100 ml of the beverage; introducing 2-8 g carbon dioxide, following the second mixing, to carbonate the beverage. The honey includes: 43-47 g fructose and 33-36 g glucose per 100 g of total mass of sugars.

### TECHNICAL FIELD

The present invention relates to a method for producing a beverage. More specifically, the present invention relates to a method for producing a non-alcoholic, preferably substantially natural beverage, known in the art as “healthy drink”. More specifically, the present invention relates to a beverage additive free such as, for example, colouring agents, antioxidants, stabilisers, preservatives and similar.

Therefore, the present invention is advantageously use in the technical field of producing and marketing beverages, in particular non-alcoholic beverages, and more specifically in the technical field of producing substantially natural beverages.

The present invention is also advantageously used in the technical field of the production of compounds and preparations for producing beverages.

### BACKGROUND ART

Many beverages, in particular non-alcoholic and substantially natural beverages, of many flavours and for many purposes are known in the relevant technical field.

In particular, there are known in the relevant technical field natural fruit and/or herbal beverages or similar known as “healthy drinks” i.e. health drinks.

In the relevant technical field, there is a variety of beverages that can be prepared from plant extracts, usually by extracting plants or plant parts with boiling water or by cooking plant parts in water.

Such known beverages may, for example, be a tea (i.e. a beverage based on an extract of Camellia sinensis leaves), or an infusion (a beverage based on the leaves, fruits or flowers of other plants, often also referred to as herbal tea).

Also known are beverages, mostly to be drunk cold, containing extracts of various herbs and/or fruits, known to the public to be endowed with vitamins and other properties beneficial to the body (hence the term health drinks or healthy drinks).

Usually, health drinks are produced by extracting fruit, vegetables, plants or similar, directly from the vendor, using an extractor, for the purpose of immediate consumption.

There are also known health drinks, normally sold inside plastic bottles, intended for longer-term consumption by the user.

Such well-known beverages have in practice proved to be not without drawbacks.

The main drawback is that known-type beverages, in particular known-type health drinks, are generally characterised by an unpleasant taste, due to the mixing of exotic fruit and/or vegetables and/or herbs, which together define a taste that is difficult to appreciate by the user who drinks the beverage solely for the desired beneficial effect.

A further drawback is that beverages of the known type normally contain bitter components or contain artificial sweeteners, which are not appreciated by users and consumers of health drinks.

### PURPOSES OF THE INVENTION

It is an object of the present invention to propose a method for producing a beverage which enables the above requirements to be met, at least in part, and to overcome, at least in part, the above drawbacks of the known art.

A further purpose of the invention is to provide a method for producing a beverage having organoleptic properties satisfactory and/or appreciable by consumers.

A further purpose of the invention is to provide a method for producing a beverage that is economical and/or energy efficient.

A further purpose of the present invention is to provide a method for producing a beverage that is functionally completely reliable.

A further purpose of the present invention is to provide a method for producing a beverage that is easy to implement.

A further purpose of the present invention is to provide a method for producing a beverage that is nutrient and/or vitamin rich.

A further purpose of the present invention is to provide a method for producing a beverage that allows obtaining a healthy beverage, i.e. a substantially natural beverage capable of at least partially satisfying the daily requirement of vitamins.

It is a further purpose of the present invention to provide a method for producing a beverage that is an alternative and/or an improvement over conventional solution.

Another purpose of the present invention is to provide a method for producing a beverage which is alternative and/or ameliorative, both in organoleptic terms and in constitutional terms, with respect to conventional solutions.

All of these purposes, either singly or in any combination thereof, and others which will result from the following description are achieved, according to the invention, by a method for producing a beverage having the characteristics set forth in claim 1.

### SUMMARY OF THE INVENTION

All the purposes, either singly or in any combination thereof, and others which will result from the following detailed description are achieved, according to the invention, by a method for preparing a beverage having the characteristics set forth in independent claim 1.

### BRIEF DESCRIPTION OF THE FIGURES

The present invention is hereinafter further clarified in some preferred embodiments thereof, shown for illustrative and non-limiting purposes only, with reference to the appended drawings, wherein:

FIG. 1 shows a comparison graph between the beverage according to the invention and another similar beverage known on the market, illustrating glycaemic absorption in healthy subjects thirty minutes after intake.

### DETAILED DESCRIPTION OF THE INVENTION

The method for producing a beverage object of the present invention is suitably use in the technical field of production and marketing of beverages, in particular non-alcoholic beverages.

Advantageously, the beverage obtainable by means of the method subject matter of the present invention is a substantially natural beverage, i.e., produced by using only non-artificial ingredients with only the addition of vitamins and/or mineral salts, as described in detail below.

The method for producing a beverage, which is the subject matter of the present invention, comprises at least the operational steps described in detail below.

Preliminarily, the method comprises a step of preparing at least a volume of concentrated fruit juice. The concentrated fruit juice used in the method according to the invention is obtained by the removal of at least 30% water from a natural fruit juice, in a known manner to the person skilled in the art.

Furthermore, the method according to the invention comprises a step of preparing a volume of concentrated elderberry juice.

In order to carry out this preparation step, the method preferably comprises a step of storing raw material, i.e. fruit. More specifically, the method comprises, in a known manner, storing the fruit within temperature-controlled cold rooms, in order to control the ripening of the fruit.

Preferably, the storage phase involves keeping the fruit at a substantially constant temperature of about 3 to 5° C.

Preferably, the storage phase involves controlling the relative humidity of the environment in which the fruit is stored, in particular the environment of said cold storage room.

In this way, the raw material, i.e., the fruit, will retain substantially unchanged physical and chemical characteristics while preserving organoleptic properties and noble contents such as vitamins and antioxidants.

Preferably, the method according to the invention thus comprises a washing step of the raw material, i.e. in particular of the fruit.

More in detail, the washing step comprises soaking the raw material in a special tank for detaching soil residues and any other impurities.

Subsequently, the method according to the invention comprises a selection step, in which operators select fruit suitable for undergoing the subsequent operational steps from fruit unsuitable, for example due to over-ripening. More in detail, the selection phase takes place on special tables, e.g. made of stainless steel, discarding 20 any fruit that is unsuitable and/or with the removal of unhealthy parts thereof, because for example spoilt.

Advantageously, in accordance with a preferred embodiment of the present invention, the step of preparing said fruit juice concentrate comprises at least one sub-step of extracting juice from at least one fruit to obtain at least one volume of fruit juice, in particular by means of at least one extractor.

The term “fruit juice” shall be understood hereafter, for the purposes of this privative, to mean any predominantly liquid substance obtained directly from the fruit by squeezing and/or crushing and/or extracting or other similar known methods to the person skilled in the art.

Advantageously, the preparation step and in particular the extraction step involves extracting fruit juice from citrus fruits. More specifically, the extraction sub-step involves extracting at least one volume of orange juice and at least one volume of lemon juice.

Preferably, the extraction step involves extracting juice from said citrus fruits using at least one extractor.

Advantageously, the extraction step is performed by means of a cold procedure.

More in detail, the extraction step comprises crushing, e.g. pressing and at least one sub-phase of grazing.

More in detail, the grazing sub-phase (also known in the relevant technical field as bridging, or high pressure processing HPP-Process—or hydrostatic high pressure processing) involves sealing the fruit and placing it in a steel compartment containing a liquid, in particular water, and pumps are used to generate pressure inside the compartment. Suitably, the pumps can apply pressure either constantly or intermittently. In this way, the application of high hydrostatic pressure (HHP) to a food product, particularly fruit and more specifically citrus fruit, kills many microorganisms.

Advantageously, during the washing phase, the method provides for the addition of natural sanitisers, so that the bacterial load on the fruit is reduced as much as possible, obviating the risk of carrying it into the subsequent operational phases envisaged by the method.

Advantageously, the provision of natural sanitisers during the washing phase increases the effectiveness of the grazing phase.

Suitably, in accordance with a first embodiment, the extraction phase is performed cold. In more detail, the extraction phase involves introducing the fruit into an extractor comprising appropriate presses (particularly pack presses or vertical presses), preferably after it has been suitably drained on tables with a perforated surface.

Following the extraction phase, a juice is obtained, which is then advantageously conveyed into a collecting tray.

With this type of cold extraction, following the extraction phase, a semi-finished product loaded with fibre is obtained, which is preferably subjected to a further separation phase between the more fluid and watery part and the more solid and fibrous part.

Otherwise, following or instead of the separation step, the method may provide a homogenisation step. In particular, the homogenisation step involves the mixing of mutually insoluble phases (in this case liquid part and fibre part) in order to obtain a suspension or emulsion, i.e. a chemically homogeneous mixture.

In accordance with a further embodiment, the extraction step can be performed hot. More specifically, the hot extraction step preferably involves a blanching step (i.e. blanching or blanching). The blanching phase advantageously involves blanching the fruit in boiling water, which is removed after a short interval of time and finally immersed in ice water or placed under cold running water to stop the cooking process started in the boiling water.

In this way, the blanching phase inactivates enzymes that cause fruit spoilage, such as browning, as well as structural changes and unpleasant odours in the treated fruit. More specifically, the enzymes that cause fruit spoilage comprise lipoxygenase and/or polyphenol oxidase and/or polygalacturonase and/or chlorophyllase.

Following the blanching phase, the hot extraction phase advantageously involves introducing the fruit into centrifugal sieving machines, in particular equipped with baskets with a sieve, preferably fine mesh, after it has been suitably drained on tables with a perforated plate.

With this type of hot extraction, the fruit juice obtained is loaded with fibre (i.e. a solid part suspended within the liquid part of the juice). In order to separate the fibres from the liquid part, the method may advantageously comprise a further separation step of the fibre part and/or a further blanching step. Indeed, subsequent separation and/or further blanching treatments may mitigate the separation between the fibre and the liquid part of the packaged beverage.

Suitably, following or instead of the separation and/or further blanching step, the method may comprise a homogenisation step. In particular, the homogenisation step involves the mixing of mutually insoluble phases (in this case, part liquid and part fibre) in order to obtain a suspension or emulsion, i.e. a chemically homogeneous mixture.

More in detail, the homogenisation phase involves the fruit being placed inside a homogeniser, which subjects the fruit to a forced passage through openings smaller than the size of the fruit itself, using a pump, in particular a discontinuous pump, which suitably generates sudden changes in energy, in particular changes from potential energy (high pressure up to 350 MPa with low speed) to kinetic energy (low pressure with high speed).

In this way, the homogeniser generates a phenomenon of turbulence (intense vortices created in the liquid upon conversion from potential energy to kinetic energy with the production of significant local velocity gradients capable of fragmenting the particles), and cavitation (hollow bubbles generated by the drop in pressure and consequent shock waves as the bubbles implode). The result is an amalgamation of the more solid and the more liquid parts into a chemically substantially homogeneous mixture.

Alternatively, in accordance with a further embodiment, the hot extraction phase can be realised by inserting the fruit inside suitable steam-flow extractors (known to the skilled man in the art and therefore not described in detail below).

Preferably, following the extraction phase (be it cold or hot), the method may comprise a deareation phase, which involves subjecting the juice obtained from the extraction phase to a low-pressure environment, preferably one in which a vacuum has been created, in order to extract micro-bubbles of oxygen trapped in the product to decrease oxidative risks and increase the time of organoleptic stability decay.

Suitably, the preparation phase also comprises at least one phase of extraction of elderberry juice from elderberries by pressing.

More specifically, the extraction step comprises the use of a hydraulic press and/or a belt press, known to the person skilled in the art.

Preferably, the step of preparing said volume of fruit juice comprises a step of concentrating said volume of fruit juice and said elderberry juice to obtain a volume of concentrated fruit juice, in particular an evaporation step using at least one evaporator.

More specifically, the evaporation step involves the change of state of the volume of fruit juice from a liquid to an aeriform state which, in the presence of a vacuum, takes place at a lower temperature than the boiling temperature at atmospheric pressure, thereby making it possible to benefit from considerable energy savings and the preservation of the organoleptic properties of the juice itself.

This technique separates a non-volatile component from a solution, thus obtaining demineralised water on the one hand and a more concentrated juice in the other components on the other.

Preferably, following the preparation step, the method comprises a step of filtering said volume of fruit juice.

The method according to the invention thus comprises a first step of mixing said volume of concentrated fruit juice together with at least a first volume of water and a mass of vitamins, to obtain a compound.

Preferably, the first mixing step comprises mixing together with the volume of concentrated fruit juice also flavours and/or zinc.

Advantageously, following the mixing step, the method comprises a packaging step, preferably packaging the compound in an aseptic environment in 20-25 litre bags.

Advantageously, the compound obtained following the first mixing step has a pH of between 2.60 and 3.60.

The method for producing said beverage then comprises a second mixing step, wherein within a volume of water a mass of said compound of between 30-80 g for each litre of said volume of water and at least a mass of honey of between 70-130 g for each litre of said volume of water is mixed, to obtain said beverage.

Preferably, the second mixing step comprises mixing a mass of between 45-65 g per litre of said volume of water. More preferably, the second mixing step of the method according to the invention comprises mixing a mass of compound of between about 50-54 g per litre volume of water.

More preferably, the second mixing step comprises mixing a mass of honey of between 90-110 g per litre volume of water. More preferably, the second mixing step involves mixing a mass of honey of approximately 100 g per litre volume of water.

More specifically, the beverage according to the invention comprises a mass of fruit juice between 15-30% of the total mass of said beverage.

Preferably, the beverage comprises a mass of fruit juice between 18-25% of the total mass of said beverage and more preferably a mass of fruit juice about equal to 23% of the total mass of said beverage.

Advantageously, the beverage comprises a mass of orange juice between 15-25% of the total mass of said beverage and more preferably about equal to about 20% of the total mass of said beverage. Similarly, the beverage preferably comprises a mass of lemon juice between 1-8% of the total mass of the beverage, in particular between 2-5% of the total mass and more preferably about equal to about 3% of the total mass of the beverage.

Further, the beverage comprises a mass of elderberry juice between 0.1%-2% of the total mass of the beverage. Preferably, the beverage comprises a mass of elderberry juice between 0.2%-1% of the total mass of the beverage and more preferably about 0.5% of the total mass of the beverage.

The beverage obtained by the method according to the invention further comprises a vitamin mass of between 3-6 mg per 100 ml of said beverage.

Advantageously, said vitamin mass of said beverage is between 4-5 mg per 100 ml of said beverage.

In accordance with a preferred embodiment of the present invention, said first mixing step of said vitamin mass of said compound is carried out such that said beverage comprises:
a vitamin E mass of between 1-3 mg per 100 ml of said beverage, and/or
a thiamine mass of between 0.1-0.25 mg per 100 ml of said beverage, and/or
1.5-3.5 mg niacin per 100 ml of said beverage, and/or
a vitamin B6 mass between 0.1-0.3 mg per 100 ml of said beverage, and/or
a mass of vitamin B12 between 0.3-0.45 μg per 100 ml of said beverage, and/or
a mass of biotin of between 6-9 μg per 100 ml of said beverage.

Preferably, said first step of mixing said vitamin mass of said compound is carried out such that said beverage comprises:
a vitamin E mass of about 1.8 mg per 100 ml of said beverage, and/or
a thiamine mass of about 0.165 mg per 100 ml of said beverage, and/or
a mass of niacin of about 2.4 mg in 100 ml of said beverage, and/or
a vitamin B6 mass of about 0.21 mg per 100 ml of said beverage, and/or
a mass of vitamin B12 of about 0.375 μg per 100 ml of said beverage, and/or
a mass of biotin of about 7.5 μg per 100 ml of said beverage.

Suitably, said first step of mixing said vitamin mass of said compound is carried out such that said beverage comprises:
a vitamin E mass of about 15% of the daily requirement (NRV, nutritional reference values), and/or
a thiamine moiety of about 15% of the daily requirement, and/or
a mass of niacin of approx. 15% of the daily requirement, and/or
a vitamin mass of about 15% of the daily requirement, and/or
a vitamin mass of about 15% of the daily requirement, and/or
a mass of biotin equal to about 15% of the daily requirement.

Advantageously, said first mixing step further comprises mixing a mass of zinc, such that the mass of zinc in said beverage is between 5-9 mg per 100 ml of said beverage.

More preferably, said first mixing step comprises mixing said zinc mass, such that the mass of zinc in said beverage is about 7 mg per 100 ml of said beverage.

Conveniently, said first blending step comprises mixing said zinc mass, such that the mass of zinc in said beverage is about 70% of the daily requirement (NRV, nutritional reference values).

Advantageously, the honey of said mass of honey provided in said second mixing step has a pH value between 3.5-5.

Advantageously, the honey of said honey mass contemplated in said second mixing step is provided with an amount of free acids less than or equal to 50 nmol/kg.

Advantageously, the honey of said honey mass provided in said second blending step has a relative humidity of less than or equal to 20%.

Advantageously, said honey of said honey mass provided in said second blending step is provided with a mass of fructose dehydration products and in particular a mass of hydroxymethylfurfural (HMF) less than or equal to 40 mg per kg of honey.

Advantageously, said honey comprises a mass of sugars, wherein fructose is between 43-47 g per 100 g of total sugar mass and glucose is between 33-36 g per 100 g of total sugar mass.

Advantageously, said honey comprises amino acids in amounts of less than 0.004% of the total mass of honey.

Advantageously, said honey comprises polyphenols in an amount of less than 0.03% of the total mass of honey.

Advantageously, the method according to the invention does not comprise any added sugars other than those comprised in said honey.

The beverage obtained by means of the method according to the invention has been tested (under secrecy) by international organisation, such as in particular the International Taste Institute, which defines the beverage in question as “An impressive product with a balanced taste and harmonious aromas” as well as having “A very attractive visual appearance with a beautiful pale pink colour' and ‘The nose is pleasant and inviting, with expressive aromas of bitter orange and fruit’ Therefore, it is clear that the particular method according to the invention has the objective technical effect of obtaining a beverage with a particular taste, colour and aroma.

Moreover, the provision of the honey having the aforementioned characteristics allows to limit the absorption of glycaemia by the user taking the beverage.

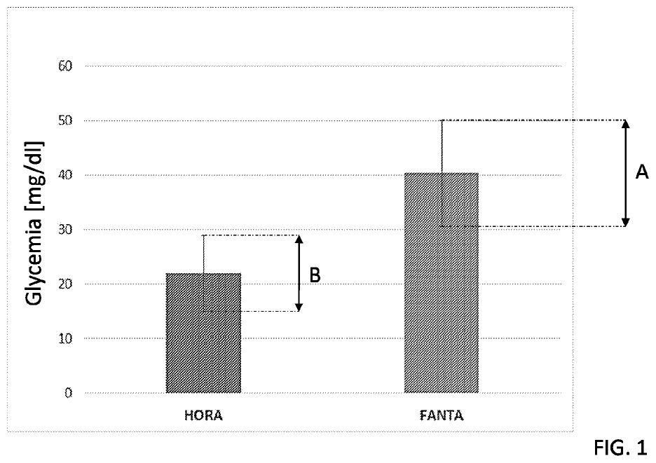

With particular reference to the annexed FIG. 1, the Applicant has carried out numerous tests on different users who consumed the beverage according to the present invention, comparing the test with the consumption of a further carbonated beverage well known in the market under the brand Fanta®.

As can be clearly seen, the particular prediction that said mass of honey comprises a mass of sugars, wherein fructose is between 43-47 g per 100 g of total mass of sugars and glucose is between 33-36 g per 100 g of total mass of sugars allows for a drastic decrease in the assimilation of blood sugar by the user.

More in detail, it was observed that thirty minutes after drinking the beverage according to the invention the average blood glucose assimilation by the user is about 20 mg/dl. In contrast, it was observed that thirty minutes after drinking the beverage known and commercially available under the brand Fanta®, the average blood glucose assimilated by the user is about 40 mg/dl, i.e. about twice as high.

In particular, following a plurality of measurements, it has been found that following the intake of the known beverage Fanta®, the assimilation of blood glucose varies in a range A between 32 and 52 mg/dl, whereas following the intake of the beverage subject matter of the present invention, the assimilation of blood glucose varies in a range B between 14 and 28 mg/dl.

These results demonstrate the technical effect of the method according to the invention, i.e. it allows to obtain and/or make available a beverage with reduced blood glucose assimilation by the user, effectively defining a healthy beverage suitable to be consumed also by sports users or similar. In accordance with a further embodiment, the method of the present invention comprises, following said second mixing step, at least one carbon dioxide (CO2) introduction step to make said beverage a carbonated beverage.

Preferably, the step of introducing carbon dioxide comprises introducing a mass of carbon dioxide of between 2-8 g per litre of beverage and preferably of about 4 g per litre of beverage.

Thus, the method according to the invention advantageously provides for a packaging step of said beverage.

More in detail, the step of packaging the beverage comprises placing a predetermined volume inside a container, such as, for example, a bottle or, more preferably, a can.

More specifically, the empty containers are first ‘blown’ with a special blower to remove any foreign bodies.

The beverage may be hot-packed (by entirely hot processes) or cold-packed (by entirely cold processes) in glass or PET bottles suitable for high temperatures using, in particular, a pneumatic volumetric dispenser with a predetermined volume system or, in the case of semi-limpid/limpid juices (i.e. with low fibre content) using a level filler.

Preferably, in the case of packaging in glass containers, the beverage packaging step involves immediately closing the glass containers with capsules, e.g. twist-off.

Preferably, in the case of packaging in plastic containers, e.g. PET, the step of packaging the beverage comprises immediately closing the plastic containers with pre-threaded plastic caps, by means of a capping machine, e.g. equipped with twist-off control to increase the guarantee of an optimal closure.

Suitably, the packaging step of the beverage is carried out in the shortest possible time, in order to reduce the risk of possible contamination by external agents and the contact with oxygen and the consequent risk of oxidation of the product is reduced.

The method according to the invention also preferably comprises a treatment at high pressure (in particular up to 6 kbar) which, together with the setting of appropriate environmental parameters (brix degrees and pH), confers a sanitising effect on the beverage, modifying the cellular structure of the microbial forms potentially dangerous to human health, while at the same time not affecting the organoleptic characteristics of the beverage, increasing its usability over time once packaged (i.e. shelf life).

In accordance with a different embodiment, following the packaging phase of the beverage, the method according to the invention preferably comprises a further heat treatment phase, in particular a sterilisation phase, advantageously at a low temperature.

Advantageously, the heat treatment phase is a pasteurisation phase which, by setting the aforementioned appropriate parameters (brix degrees and pH) and in the absence of oxygen, in a manner in itself known to the technician in the field, allows the elimination of pathogenic forms and certain microorganisms, while inerting others such as yeasts and spores (e.g. botulinum spores), avoiding replication with consequent release of toxins.

Advantageously, the heat treatment phase is carried out by immersion. More specifically, the packages (particularly bottles) of beverages are placed in a special basket that will be introduced into the pasteurisation tank, which is filled with boiling water that will reach the temperature necessary to bring the product inside the package to a predetermined temperature, normally between 65°° C. and 85° C.

The heat treatment phase is advantageously carried out by monitoring, by means of a detection probe, the temperature inside the packages, in particular by measuring the temperature in a package equipped with a sensor (known in jargon as a witness package), to ensure that the product has reached the aforementioned pre-established pasteurisation temperature. This phase advantageously ends with a cooling sub-phase, in which the temperature is lowered by adding cold water to the pasteurisation vat, or by immersing the basket in a cooling tank.

Finally, the method according to the invention advantageously comprises a labelling step, in which the beverage package is labelled. The packages (i.e. the jars and/or bottles) are preferably placed on a suitable labelling machine configured to apply the label (and possibly a back label) in self-adhesive. Advantageously, the labelling step further comprises, by means of a machine accessory comprising a stamping unit, printing the batch number and expiry date on the label.

It is also an object of the present invention to provide a beverage, in particular a non-alcoholic, advantageously substantially natural beverage, preferably obtainable by means of the method described herein.

The beverage according to the invention comprises at least one volume of water, at least one mass of honey between 70-130 g per litre of said volume of water, at least one mass of fruit juice between 15-30% of the total mass of said beverage and at least one mass of vitamins between 3-6 mg per 100 ml of said beverage.

Advantageously, the honey mass of the beverage is between 90-110 g per litre of water. More preferably, the honey mass is about 100 g per litre volume of water. Preferably, the beverage comprises a mass of fruit juice between 18-25% of the total mass of said beverage and more preferably a mass of fruit juice about equal to 23% of the total mass of said beverage.

Advantageously, the beverage comprises a mass of orange juice, and preferably concentrated elderberry juice, between 15-25% of the total mass of the beverage and more preferably about equal to about 20% of the total mass of the beverage.

Similarly, the beverage preferably comprises a mass of lemon juice between 1-8% of the total mass of the beverage, in particular between 2-5% of the total mass and more preferably about equal to about 3% of the total mass of the beverage.

Advantageously, said vitamin mass of said beverage is between 4-5 mg per 100 ml of said beverage. In accordance with a preferred embodiment of the present invention, said beverage comprises:
a vitamin C mass of between 6-18 mg per 100 ml of said beverage, and/or
a vitamin E mass of between 1-3 mg per 100 ml of said beverage, and/or
a thiamine content of 0.1-0.25 mg per 100 ml of the beverage, and/or
1.5-3.5 mg niacin per 100 ml of said beverage, and/or
a mass of vitamin B6 between 0.1-0.3 mg per 100 ml of such a beverage, and/or
a mass of vitamin B12 between 0.3-0.45 μg per 100 ml of said beverage, and/or
a mass of biotin of between 6-9 μg per 100 ml of said beverage.

More preferably, said beverage comprises:
a vitamin C mass of about 12 mg per 100 ml of said beverage, and/or
a vitamin E mass of about 1.8 mg per 100 ml of said beverage, and/or
a mass of thiamine of about 0.165 mg per 100 ml of said beverage, and/or
a mass of niacin of about 2.4 mg per 100 ml of said beverage, and/or
a vitamin B6 mass of about 0.21 mg per 100 ml of said beverage, and/or
a mass of vitamin B12 of about 0.375 μg per 100 ml of said beverage, and/or
a mass of biotin of about 7.5 μg per 100 ml of said beverage.

Suitably, said beverage comprises:
a vitamin E mass of about 15% of the daily requirement (NRV, nutritional reference values), and/or
a mass of thiamine equal to about 15% of the daily requirement, and/or
a mass of niacin of approx. 15% of the daily requirement, and/or
a vitamin mass of about 15% of the daily requirement, and/or
a vitamin mass of about 15% of the daily requirement, and/or
a mass of biotin equal to about 15% of the daily requirement.

Advantageously, in accordance with an embodiment of the present invention the beverage is a carbonated beverage. For this purpose, the beverage suitably comprises a carbon dioxide mass of between 2-8 g per litre of beverage and preferably about 4 g per litre of beverage.

Advantageously, said beverage according to the invention comprises a mass of zinc between 5-9 mg per 100 ml of said beverage. More preferably, the mass of zinc in said beverage is about 7 mg per 100 ml of said beverage.

In accordance with a further embodiment, said beverage according to the invention comprises a zinc mass of between 0.5-3 mg per 100 ml of said beverage. More preferably, the mass of zinc in said beverage is about 1.5 mg per 100 ml of said beverage.

Suitably, the mass of zinc in said beverage is about 70% of the daily requirement (NRV, nutritional reference values).

It is clear from the above that the method for producing a beverage and the beverage obtained by said method, according to the invention, are particularly advantageous in that:
the beverage has taste and, in general, organoleptic properties that are highly appreciated by the public;
the beverage thus obtained is made from natural products, without the addition of preservatives, colouring agents or other additives;
the beverage thus obtained is rich in vitamins, zinc, and generally beneficial properties for the body, helping to meet the daily requirement of many vitamins;
the method is functionally completely reliable;
the method used allows to obtain a beverage which is an alternative and/or an improvement over traditional beverage.

The present invention has been illustrated and described in a preferred embodiment thereof, but it is understood that variations in embodiment may be made to it in practice, without, however, departing from the scope of protection of the present patent for industrial invention.

1. Method for producing a beverage, comprising:
preparing at least a volume of concentrated fruit juice, obtained by removing at least 30% of the water volume of a fruit juice;
preparing a volume of concentrated elderberry juice;
mixing, firstly, said volume of concentrated fruit juice, and concentrated elderberry juice, together with at least a first volume of water and a vitamin mass, to obtain a compound;
mixing, secondly, within a volume of water, a mass of said compound of between 45-65 g for each liter of said volume of water and at least one mass of honey of between 90-110 g for each liter of said volume of water is mixed, to obtain said beverage, which comprises:
a mass of fruit juice concentrate of between 15-25% of the total mass of said beverage;
a mass of vitamins, wherein said vitamins comprises vitamin E, thiamine, niacin, vitamin B6, vitamin B12 and biotin, of between 3-6 mg per 100 ml of said beverage;
introducing a mass of carbon dioxide between 2-8 g, provided for after said second mixing step, to make said beverage a carbonated beverage;
wherein said honey comprises a mass of sugars, in which fructose is between 43-47 g per 100 g of total mass of sugars and glucose is between 33-36 g per 100 g of total mass of sugars.

2. The method for producing a beverage according to claim 1, wherein said mass of fruit juice and said mass of elderberry juice of said beverage is between 18-25% of the total mass of said beverage.

3. The method for producing a beverage according to claim 2, wherein said vitamins comprises vitamin E, thiamine, niacin, vitamin B6, vitamin B12 and biotin, and wherein said mass of vitamins of said beverage is between 4-5 mg per 100 ml of said beverage.

4. The method for producing a beverage according to claim 1, wherein preparing said fruit juice concentrate comprises:
extracting juice from at least a fruit to obtain at least a volume of elderberry juice using at least an extractor;
extracting elderberry juice from said elderberries by pressing;
concentrating said volume of fruit juice and said elderberry juice to obtain a volume of concentrated fruit juice by means of at least an evaporator.

5. The method for producing a beverage according to claim 1, wherein in said first mixing said mass of vitamins of said compound is made such that said beverage comprises:
a vitamin E mass of between 1-3 mg per 100 ml of said beverage;
a thiamine mass of between 0.1 and 0.25 mg per 100 ml of said beverage;
a mass of niacin of 1.5 to 3.5 mg in 100 ml of such a beverage;
a mass of vitamin B6 between 0.1 and 0.3 mg in 100 ml of the beverage; and
a vitamin B12 mass between 0.3-0.45 μg per 100 ml of said beverage; and
a mass of biotin between 6-9 μg per 100 ml of said beverage.

6. The method for producing a beverage according to claim 1, wherein in said first mixing further comprises mixing a mass of zinc, such that the mass of zinc in said beverage is between 5-9 mg per 100 ml of said beverage.

7. The method for producing a beverage according to claim 1, wherein the honey in said honey mass provided in said second mixing has a pH value of between 3.5-5.

8. The method for producing a beverage according to claim 7, wherein the honey of said honey mass provided in said second mixing is provided with an amount of free acids less than or equal to 50 nmol/kg.

9. The method for producing a beverage, according to claim 8, wherein said honey of said mass of honey provided in said second mixing is provided with a mass of fructose dehydration products, and a mass of hydroxymethylfurfural (HMF), less than or equal to 40 mg per kg of honey.

10. The method for producing a beverage according to claim 9, wherein said honey comprises amino acids in an amount less than 0.004% of the total mass of honey.

11. The method for producing a beverage, according to claim 11, wherein said honey comprises polyphenols in an amount of less than 0.03% of the total mass of honey.

12. The method for producing a beverage, according to claim 11, wherein the beverage does not comprise any added sugars other than those comprised in said honey.
